(19) United States
(12) Patent Application Publication
(10) Pub. No.: US 2017/0095755 A1
(43) Pub. Date: Apr. 6, 2017

(54) GAS STRIPPING AND FLUID CONDITIONING APPARATUS AND METHODS OF USE

(71) Applicant: Hess Corporation, New York, NY (US)

(72) Inventors: James F. Langer, Houston, TX (US); Paul J. Blanda, Houston, TX (US); Keenan R. Foy, Houston, TX (US)

(21) Appl. No.: 15/282,519

(22) Filed: Sep. 30, 2016

Related U.S. Application Data
(60) Provisional application No. 62/236,377, filed on Oct. 2, 2015.

(51) Int. Cl. B01D 19/00

(52) U.S. Cl. CPC B01D 19/0005; B01D 19/0063; B01D 19/0068

(57) ABSTRACT

Systems, apparatuses, and methods for conditioning fluid, for example, to reduce the concentration of a contaminant in a fluid are provided. In one embodiment, the method comprises: introducing a contaminated fluid and a first stripping gas into a first vessel; contacting the contaminated fluid with the first stripping gas to reduce the concentration of a contaminant in the contaminated fluid; transferring the contaminated fluid into a second vessel; introducing a second stripping gas into the second vessel; and contacting the contaminated fluid with the second stripping gas to further reduce the concentration of the contaminant in the contaminated fluid.

### BACKGROUND

The present disclosure relates to systems, apparatuses, and methods for conditioning fluid, for example, to reduce the concentration of a contaminant in a fluid.

Fluids produced from well bores penetrating a subterranean formation, such as hydrocarbons and water, may contain significant quantities of contaminants, such as hydrogen sulfide. These contaminants can be highly toxic and/or unsafe for the environment or in handling. Thus, the presence of these components in fluids is undesirable, and the concentration of these contaminants in fluids is often regulated.

Gas stripping methods are commonly employed to remove contaminants from a contaminated fluid. Some conventional methods for stripping contaminants from fluids utilize a single vertical column with multiple trays or a packed bed wherein a stripping gas may be passed into the column and upward through the multiple trays or packed bed. These conventional stripping columns may be as large as 60 feet tall and are not readily transportable. Due to their size, the conventional stripping columns often cannot be located at the well site. Instead, contaminated fluids must be transported by truck or rail, sometimes long distances over public and private roads, to a downstream facility where a stripping column is located. Transportation of contaminated fluids may give rise to additional safety and environmental hazards along the way.

Other conventional methods for stripping contaminants from fluids involve the use of scavengers or other treatment chemicals. However, these treatment chemicals can be prohibitively expensive. Additionally, downstream facilities may not accept a treated fluid if it contains too much of the treatment chemicals.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fluid conditioning system in accordance with certain embodiments of the present disclosure.

FIG. 2 is a diagram illustrating another example of a fluid conditioning system in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure. To facilitate a better understanding of the present disclosure, the following examples of certain embodiments are given. In no way should the following examples be read to limit, or define, the scope of the disclosure.

The present disclosure relates to systems, apparatuses, and methods for conditioning fluid, for example, to reduce the concentration of a contaminant in a fluid. More particularly, the present disclosure relates to systems, apparatuses, and methods for reducing the concentration of a contaminant in a fluid via gas stripping.

In certain embodiments, the apparatuses of the present disclosure may comprise a series of vessels that are in fluid communication with one another. In certain embodiments, the systems of the present disclosure may comprise a contaminated fluid tank, a pump, a gas stripper apparatus, a separator, and/or a treated fluid tank. In certain embodiments, the methods of the present disclosure may comprise introducing a first stripping gas and a contaminated fluid comprising a contaminant into a first vessel of the gas stripper apparatus, contacting the contaminated fluid with the first stripping gas to reduce the concentration of the contaminant in the contaminated fluid, transferring the contaminated fluid to a second vessel of the gas stripper apparatus, introducing a second stripping gas into the second vessel, and contacting the contaminated fluid with the second stripping gas to further reduce the concentration of the contaminant in the contaminated fluid.

Among the many potential advantages to the systems, apparatuses, and methods of the present disclosure, only some of which are alluded to herein, the systems, apparatuses, and methods of the present disclosure may, among other benefits, provide for more efficient stripping capabilities as compared to conventional stripping methods due to, at least in part, the use of multiple vessels and the introduction of new (e.g., uncontaminated) stripping gas in each of the vessels of the apparatus. The systems, apparatuses, and methods of the present disclosure may achieve a significant reduction in the concentration of the contaminant in the contaminated fluid such that the need for any chemical treatment of the contaminated fluid may be at least partially reduced and/or entirely eliminated. In certain embodiments, the systems, apparatuses, and methods of the present disclosure may reduce the concentration of volatile hydrocarbon content in the contaminated fluid which may allow for safer transport of the contaminated fluid.

The systems and apparatuses of the present disclosure also may be modular in construction, which may provide flexibility such that the number of vessels used in a particular method or system can be adjusted based on, for example, the initial concentration of the contaminant in the contaminated fluid, the Reid vapor pressure of the contaminated fluid, and/or the volume of contaminated fluid to be treated. In certain embodiments, the systems and apparatuses of the present disclosure may be smaller in size and/or lighter in weight than conventional stripping systems and apparatuses, which may provide for, among other benefits, the ability to safely transport the systems and apparatuses under applicable transportation regulations (e.g., U.S. Department of Transportation regulations) and/or the ability to use the systems and apparatuses in remote and/or offshore locations.

In certain embodiments, the operating conditions of the systems and apparatuses of the present disclosure may be maintained such that additional advantages may be achieved over conventional stripping systems and apparatuses. For example, in certain embodiments, the systems and apparatuses of the present disclosure may operate (e.g., facilitate the flow of fluid there through) using differential pressure rather than electrical apparatuses, which may reduce or eliminate the need for any additional power and/or heat inputs. The lack of electrical apparatuses, in some embodiments, may allow for the systems and apparatuses of the present disclosure to be located or used in more regions of a well site, among other reasons, because no electrical classification is required for the systems and apparatuses. In certain embodiments, the systems and apparatuses of the present disclosure may be operated at low pressure, which may allow for the use of piping as the vessels as opposed to the more expensive and complex pressure vessels that are conventionally used for stripping contaminants. In certain embodiments, the systems, apparatuses, and methods of the present disclosure may be capable of safe continuous operation without a need to significantly adjust the process conditions, which may reduce the need for manned operation of the systems and apparatuses.

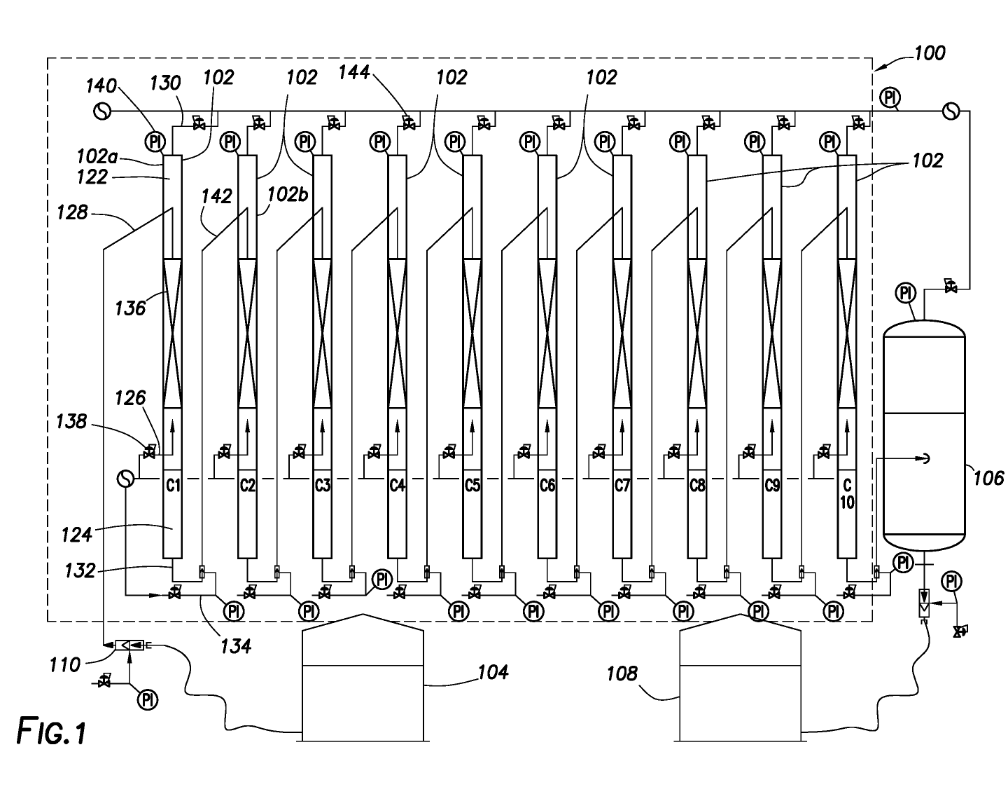

FIG. 1 depicts a fluid conditioning system in accordance with certain embodiments of the present disclosure. In certain embodiments, the fluid conditioning system may comprise a gas stripper apparatus 100. The gas stripper apparatus 100 of the present disclosure may comprise a plurality of vessels 102. As used herein, “vessel” and grammatical variations thereof may refer to any hollow container capable of holding, among other components, a liquid and/or a gas. In certain embodiments, the vessels 102 may be as complex as a pressure vessel or a simple as a length of piping. Examples of vessels that may be used in the gas stripper apparatuses of the present disclosure include, but are not limited to, pressure vessels, atmospheric tanks, frac tanks, lengths of piping, and the like. In certain embodiments, the vessels 102 may be built inside of large diameter pressure vessels using a series of weirs and baffles therein.

Although FIG. 1 depicts a system comprising ten different vessels 102, the number of vessels that may be used in the gas stripper apparatuses of the present disclosure may vary depending on, for example, the initial concentration of the contaminant in the contaminated fluid, the desired final concentration of the contaminant in the contaminated fluid, the volume of the contaminated fluid to be treated, the height of each vessel, the diameter of each vessel, and/or the temperature and the pressure of the contaminated fluid, which a person of skill in the art with the benefit of this disclosure will recognize. In certain embodiments, the number of vessels used in the gas stripper apparatuses of the present disclosure may be from about five to about ten.

In certain embodiments, one or more of the vessels 102 may be packed with a packing material 136. The packing material 136 used in the vessels 102 of the present disclosure may comprise any material known in the art suitable for creating a wetted surface to enable mass transfer. Examples of materials that may be used as packing material in the vessels of the present disclosure include, but are not limited to, rocks, Pall rings, Bialecki rings, Raschig rings, Berl saddles, Intalox saddles, static mixing inserts, and/or any combinations thereof. The size, surface area, flow area, and/or associated pressure drop may vary between different packing materials, which a person of skill in the art with the benefit of this disclosure will recognize. In certain embodiments, the same packing material may be used in all vessels of the gas stripper apparatus. In other embodiments, the packing material may vary from vessel to vessel.

As illustrated in FIG. 1, the vessels 102 may be oriented vertically. In certain embodiments, each vessel, for example vessel 102a, may have a top portion 122, a bottom portion 124, a stripping gas inlet 126, a contaminated fluid inlet 128, a contaminated stripping gas outlet 130, and a contaminated fluid outlet 132. In certain embodiments, a contaminated fluid comprising at least one contaminant at an initial concentration may enter the vessel 102a through the contaminated fluid inlet 128. The contaminated fluid from which a contaminant may be removed using in the gas stripper apparatuses of the present disclosure may comprise any fluid containing an undesired contaminant. Examples of contaminated fluids from which a contaminant may be removed using the gas stripper apparatuses of the present disclosure include, but are not limited to, hydrocarbon-based fluids (e.g., crude oil), aqueous-based fluids (e.g., water produced from a subterranean formation), and/or any combinations thereof. The contaminants that can be removed from a contaminated fluid using in the gas stripper apparatuses of the present disclosure may comprise any undesirable contaminant in the contaminated fluid. As used herein, the term “contaminant” is not necessarily limited to waste products or components in a contaminated fluid that must be discarded. Thus, the contaminant may comprise any substance or component that is simply undesired in the contaminated fluid at a particular point in time. However, these contaminants may be collected using the methods or systems of the present disclosure and re-purposed once removed from a fluid. Examples of contaminants that may be removed from a contaminated fluid using in the gas stripper apparatuses of the present disclosure include, but are not limited to, hydrogen sulfide, light (e.g., C₁-C₄) hydrocarbons, carbon dioxide, and/or any combinations thereof.

In certain embodiments, a stripping gas may enter the vessel 102a through the stripping gas inlet 126. In certain embodiments, the stripping gas inlet 126 may be located between the top portion 122 of the vessel 102a and the bottom portion 124 of the vessel 102a. In certain embodiments, the stripping gas may flow upward through the vessel 102a and contact the contaminated fluid. The stripping gases that can be used in the gas stripper apparatuses of the present disclosure may comprise any gas capable of removing the identified contaminant from the contaminated fluid. Examples of stripping gases that may be used in the gas stripper apparatuses of the present disclosure include, but are not limited to, natural gas, fuel gases, methane, ethane, propane, inert gases (e.g., nitrogen, carbon dioxide, argon), and/or any combinations or blends thereof. In certain embodiments, new (e.g., uncontaminated) stripping gas may be introduced into each of the vessels 102 in the gas stripper apparatus 100 such that the stripping gas introduced into a particular vessel 102a through the stripping gas inlet 126 does not comprise any portion of stripping gas that was introduced into any of the other vessels in the gas stripper apparatus 100. In certain embodiments, the rate at which the stripping gas is introduced into each of the vessels 102 may be adjusted using a valve 138 located on the stripping gas inlet 126, as illustrated in FIG. 1.

In certain embodiments, mass transfer of the contaminant from the contaminated fluid to the stripping gas may occur due to, at least in part, the difference in contaminant concentration between the contaminated fluid and the stripping gas, which may contain no contaminant when it enters the vessel 102a. In certain embodiments, the used of new (e.g., uncontaminated) stripping gas in each of the vessels 102 may maximize the concentration gradient between the contaminated fluid and the stripping gas in each of the vessels 102, which may result in higher efficiency of the stripping capability as compared to the stripping capability of partially contaminated stripping gas from a previous vessel.

In certain embodiments, the contaminated fluid may wet the packing material 136 inside the vessel 102a to form a thin film on the surface of the packing material 136 where the mass transfer of the contaminant therein may occur when contacted by the stripping gas. The volume of the contaminated fluid inside the vessel 102a may vary depending on the flow rates through the contaminated fluid inlet 128 and the contaminated fluid outlet 132. In certain embodiments, the vessel 102a may operate when about 100% liquid filled by volume. In such embodiments, the bubbles of the stripping gas may rise in the continuous contaminated fluid and where mass transfer may occur as the stripping gas rises. As a result of the mass transfer, the concentration of the contaminant in the contaminated fluid exiting the vessel 102a through the contaminated fluid outlet 132 may be lower than the initial concentration of the contaminant in the contaminated fluid that entered the vessel 102a through the contaminated fluid inlet 128. In certain embodiments, the concentration of the contaminant in the contaminated fluid may be incrementally reduced in as the contaminated fluid flows through each of the vessels 102 in the gas stripper apparatus 100. In certain embodiments, the concentration of the contaminant in the contaminated fluid may be reduced by up to 50% in each of the vessels. In certain embodiments, the concentration of the contaminant in the contaminated fluid that exits the final vessel in the gas stripper apparatus may be equal to or less than about 5 parts per million.

In certain embodiments, the contaminated stripping gas may exit the vessel 102a through the contaminated stripping gas outlet 130. In some embodiments, the contaminated stripping gas from each of the vessels 102 may be combined into a common header, as illustrated in FIG. 1, and also may be collected in a gas-gathering system. In some embodiments, the contaminated stripping gas may be burned in a flare. In other embodiments, the contaminated stripping gas that is collected in gas-gathering system may be sold as off-gas.

In certain embodiments, the contaminated fluid inlet 128 may be located proximate to the top portion 122 of the first vessel 102a and the contaminated fluid outlet 132 may be located proximate to the bottom portion 124 of the first vessel 102a. As depicted in FIG. 1, in certain embodiments, all of the vessels 102 in the gas stripper apparatus 100 may have this configuration. In such embodiments, the stripping gas and the contaminated fluid will flow counter-currently (i.e., in an opposite direction to one another) in each of the vessels 102. The contaminated fluid outlet 132 of the vessel 102a may be in fluid communication with the contaminated fluid inlet 142 of the subsequent vessel 102b. In certain embodiments, a lifting gas may be introduced into the contaminated fluid proximate to the contaminated fluid outlet 132 of the vessel 102a, e.g., at 134, to transport the contaminated fluid into the contaminated fluid inlet 142 of the subsequent vessel 102b. In such embodiments, no pumps and/or additional power input are required to transfer the contaminated fluid from one vessel to the next. In certain embodiments, the lifting gas may be the stripping gas. In other embodiments, the lifting gas may be a different gas than the stripping gas. In some embodiments, one or more pumps may be used to transport the contaminated fluid from the contaminated fluid outlet 132 of one vessel 102a to the contaminated fluid inlet 142 of the subsequent vessel 102b.

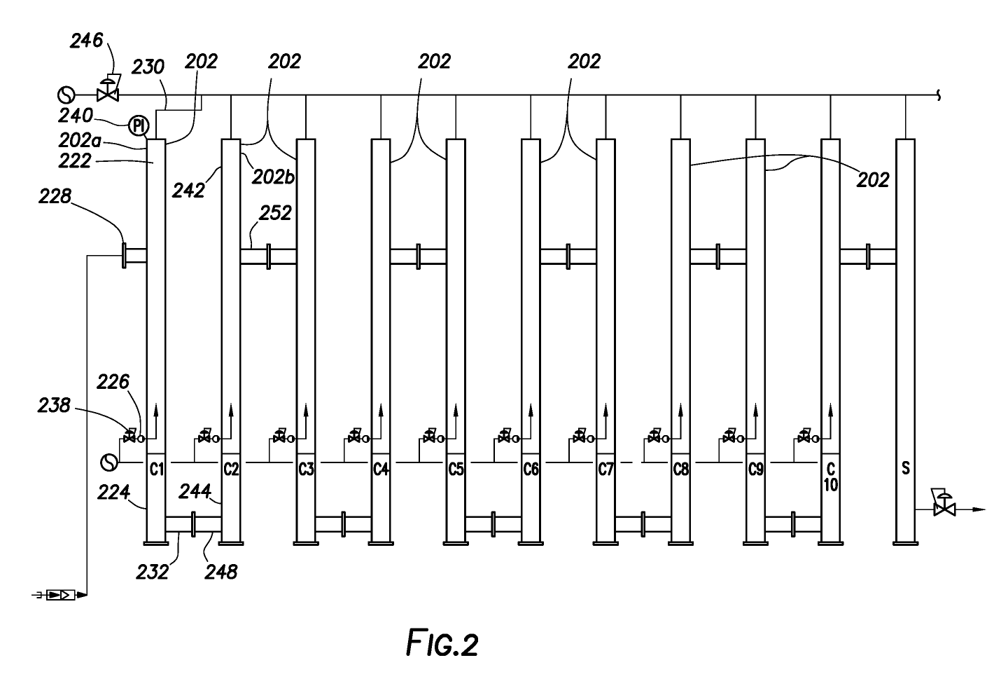

Referring now to FIG. 2, in other embodiments, the gas stripper apparatus of the present disclosure may have an alternative configuration. In such embodiments, the configuration of the first vessel 202a may be similar to the configuration of the vessels 102 depicted FIG. 1. In this configuration, the contaminated fluid inlet 228 may be located proximate to the top portion 222 of the first vessel 202a and the contaminated fluid outlet 232 may be located proximate to the bottom portion 224 of the first vessel 202a. In the embodiment depicted in FIG. 2, the configuration of second vessel 202b may be reversed such that the contaminated fluid inlet 248 of the second vessel 202a may be located proximate to the bottom portion 244 of the second vessel 202a while the contaminated fluid outlet 252 of the second vessel 202a may be located proximate to the top portion 242 of the second vessel 202a.

As in the configuration of FIG. 1, the stripping gas inlet 226 may be located between the top portion 222 of the vessel 202a and the bottom portion 224 of the vessel 202a for each of the vessels 202 in the configuration depicted in FIG. 2. In certain embodiments, the stripping gas may flow upward through the vessels 202, contacting the contaminated fluid in the process. In certain embodiments, the contaminated stripping gas may exit the vessel 202a through the contaminated stripping gas outlet 230. In certain embodiments, the rate at which the stripping gas is introduced into the vessel 202 may be adjusted using a valve 238 located on the stripping gas inlet 226, as illustrated in FIG. 2

In the embodiment depicted in FIG. 2, the contaminated fluid and the stripping gas may flow counter-currently (i.e., in an opposite direction to one another) through the first, third, fifth, and so on vessels while the contaminated fluid and stripping gas may flow co-currently (i.e., in the same direction as one another) through the second, fourth, sixth, and so on vessels. In the vessels in which co-current flow occurs, e.g., 202b, it is believed that the introduction of the stripping gas into the contaminated fluid may aerate the contaminated fluid and lower the specific gravity of the contaminated fluid in the vessel 202b, thus reducing the pressure in the bottom portion 244 of the vessel 202b. As a result of the reduced pressure in the bottom portion 224 of the vessel 202b, the contaminated fluid from the previous vessel 202a may flow into and upward through the vessel 202b. In certain embodiments, a higher flow rate of stripping gas in the vessel 202b may be desirable to aid in lifting the contaminated fluid through the vessel 202b to the contaminated fluid outlet 252 and into the subsequent vessel.

The volume of the contaminated fluid inside the vessel 102a may vary depending on the flow rates through the contaminated fluid inlet 128 and the contaminated fluid outlet 132. In certain embodiments, the vessel 202b may operate when about 100% liquid filled by volume. In such embodiments, the bubbles of the stripping gas may rise in the continuous contaminated fluid and where mass transfer of the contaminant may occur as the stripping gas rises. In such embodiments, the rising bubbles may aid in lifting the contaminated fluid upward through the vessel 202b. In certain embodiments, no pumps and/or additional power input are required to transfer the contaminated fluid from one vessel to the next.

In certain embodiments, the flow of the contaminated fluid through the vessels may occur as a result of differential pressure in the gas stripper apparatus. In certain embodiments, the pressure of each vessel may be adjusted to maintain desired differential pressures throughout the gas stripper apparatus. In such embodiments, the pressure of the vessels may be adjusted using valves located on the contaminated stripping gas outlets, as illustrated in FIGS. 1 and 2. In certain embodiments the gas stripper apparatuses of the present disclosure may be operated at a pressure of about 50 psi. In certain embodiments, the operating pressure may be determined by the back pressure at the source of the contaminated fluid being introduced into the gas stripper apparatus.

One of ordinary skill in the art with the benefit of this disclosure will recognize that the temperature at which the gas stripper apparatuses of the present disclosure may be operated may vary depending on, for example, the type of contaminant to be removed and the composition of the contaminated fluid. In certain embodiments, the gas stripper apparatuses of the present disclosure may be operated at a minimum temperature of about 100° F. In certain embodiments, the temperature of the contaminated fluid may be at or above about 100° F., and so additional heat may not need to be added to the gas stripper apparatus to reach the minimum temperature. In certain embodiments, the contaminated fluid may be at or above a temperature of about 100° F. prior to its introduction into the gas stripper apparatus due to, for example, the use of a heater treater, a heated storage tank, and/or a hot railcar.

In certain embodiments, the vessels of the gas stripper apparatuses of the present disclosure may be smaller in scale than conventional stripping apparatuses. In some embodiments, the maximum height of the vessels may be limited based at least in part on U.S. Department of Transportation regulations. In certain embodiments, the height of the vessels may be less than about 11.5 feet to allow for transportation. One of ordinary skill in the art with the benefit of this disclosure will recognize that the height of the vessels may be greater if transportation of the gas stripper apparatuses of the present disclosure is not a concern. In certain embodiments, the diameter of the vessels may be about 6 inches. In certain embodiments, when the diameter of the vessel is below 6 inches, the vessels may be constructed out of a length of piping rather than a pressure vessel under applicable pressure vessel standards (e.g., ASME's Boiler and Pressure Vessel Code, Section VIII), which may yield significant construction cost savings. In certain embodiments, the gas stripper apparatuses of the present disclosure may be mounted on a skid, which may allow for transportation to and/or use in remote and/or offshore locations.

In certain embodiments, the volume of contaminated fluid to be treated using the gas stripper apparatuses of the present disclosure may be about 100 barrels per day. In some embodiments, the residence time of the contaminated fluid in the gas stripper apparatuses of the present disclosure may be above about 1 hour. The increased residence time as compared to that of conventional stripping apparatuses may achieve a higher overall stripping efficiency. One of ordinary skill in the art with the benefit of this disclosure will recognize that the volume of contaminated fluid to be treated and/or the residence time of the contaminated fluid in the gas stripper apparatuses may vary depending on, for example, the number of vessels in the gas stripper apparatuses and/or the size of the vessels in the gas stripper apparatuses.

Referring again to FIG. 1, in certain embodiments, the systems of the present disclosure may comprise a contaminated fluid tank 104, a pump 110, a fluid conditioning apparatus 100, a separator 106, and/or a treated fluid tank 108. In certain embodiments, the systems of the present disclosure may include various valves and sensors. For example, FIGS. 1 and 2 show pressure indicators (e.g., 140, 204) and pressure control values (e.g., 144, 246) throughout the system. In certain embodiments, the contaminated fluid tank 104 and/or the treated fluid tank 108 may be on rollers to further increase the flexibility and modularity of the system. In certain embodiments, a single tank may be used as both the contaminated fluid tank 104 and/or the treated fluid tank 108. In certain embodiments, one or more pumps 110 may optionally be used to introduce the contaminated fluid into the contaminated fluid inlet 128 of the first vessel 102a in the gas stripper apparatus 100. In certain embodiments, a separator 106 may be located at the end of the gas stripper apparatus 100 to remove any foam that forms in the contaminated fluid. In certain embodiments in which one or more of vessels 202 contain packing material, the contaminated fluid may be introduced into the vessel 202a at a level just below the packing material 236, among other reasons, to aid in the removal of foam in the vessel 202a. In certain embodiments, the flow rate of the contaminated fluid through the gas stripper apparatus 100 may be controlled based on the level of the contaminated fluid in the separator 106.

An embodiment of the present disclosure is a method for reducing a concentration of a contaminant in a contaminated fluid comprising: introducing the contaminated fluid and a first stripping gas into a first vessel; contacting the contaminated fluid with the first stripping gas to reduce the concentration of the contaminant in the contaminated fluid; transferring the contaminated fluid into a second vessel; introducing a second stripping gas into the second vessel; and contacting the contaminated fluid with the second stripping gas to further reduce the concentration of the contaminant in the contaminated fluid.

Another embodiment of the present disclosure is an apparatus for reducing a concentration of a contaminant in a contaminated fluid comprising: a first vessel and a second vessel each having a top portion, a bottom portion, a stripping gas inlet located between the top portion and the bottom portion, a contaminated gas outlet located proximate to the top portion, a contaminated fluid inlet, and a contaminated fluid outlet, wherein the contaminated fluid inlet of the first vessel is located proximate to the top portion of the first vessel, wherein the contaminated fluid outlet of the first vessel is located proximate to the bottom portion of the first vessel, and wherein the contaminated fluid inlet of the second vessel in fluid communication with the contaminated fluid outlet of the first vessel.

Another embodiment of the present disclosure is a system for reducing a concentration of a contaminant in a contaminated fluid comprising: a plurality of vessels connected in series each having a top portion, a bottom portion, a stripping gas inlet located between the top portion and the bottom portion, a contaminated gas outlet located proximate the top portion, a contaminated fluid inlet, and a contaminated fluid outlet, wherein the contaminated fluid inlet of each vessel other than a first vessel in the plurality of vessels is in fluid communication with the contaminated fluid outlet of the preceding vessel; a pump in fluid communication with the first vessel in the plurality of vessels; and a separator in fluid communication with a last vessel in the plurality of vessels.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method for reducing a concentration of a contaminant in a contaminated fluid comprising:
introducing the contaminated fluid and a first stripping gas into a first vessel;
contacting the contaminated fluid with the first stripping gas to reduce the concentration of the contaminant in the contaminated fluid;
transferring the contaminated fluid into a second vessel;
introducing a second stripping gas into the second vessel; and
contacting the contaminated fluid with the second stripping gas to further reduce the concentration of the contaminant in the contaminated fluid.

2. The method of claim 1, wherein the second stripping gas does not comprise any portion of the first stripping gas.

3. The method of claim 1, wherein at least one of the first vessel and the second vessel is 100% liquid filled by volume.

4. The method of claim 1, wherein at least one of the first vessel and the second vessel has a temperature above about 100° F.

5. The method of claim 1, wherein the contaminant is selected from the group consisting of: hydrogen sulfide, a light (C₁-C₄) hydrocarbon, carbon dioxide, and any combination thereof.

6. The method of claim 1, wherein the first stripping gas and the second stripping gas are each independently selected from the group consisting of: a natural gas, a fuel gas, methane, ethane, propane, an inert gas, nitrogen, carbon dioxide, argon, and any combination thereof.

7. The method of claim 1, wherein at least one of the first vessel and the second vessel contains a packing material selected from the group consisting of: a plurality of rocks, a plurality of Pall rings, a plurality of Bialecki rings, a plurality of Raschig rings, a plurality of Berl saddles, a plurality of Intalox saddles, a plurality of static mixing inserts, and any combination thereof.

8. The method of claim 1, wherein the contaminated fluid and the first stripping gas flow counter-currently through the first vessel, and wherein the contaminated fluid and the second stripping gas flow co-currently through the second vessel.

9. The method of claim 1, wherein the concentration of the contaminant in the contaminated fluid is reduced by up to 50% in each of the first vessel and the second vessel.

10. The method of claim 1, wherein no pump is required to transfer the contaminated fluid into the second vessel.

11. The method of claim 1 further comprising:
transferring the contaminated fluid into a third vessel;
introducing a third stripping gas into the third vessel; and
contacting the contaminated fluid with the third stripping gas to further reduce the concentration of the contaminant in the contaminated fluid.

12. The method of claim 11, wherein the third stripping gas does not comprise any part of the first stripping gas or the second stripping gas.

13. An apparatus for reducing a concentration of a contaminant in a contaminated fluid comprising:
a first vessel and a second vessel each having a top portion, a bottom portion, a stripping gas inlet located between the top portion and the bottom portion, a contaminated gas outlet located proximate to the top portion, a contaminated fluid inlet, and a contaminated fluid outlet,
wherein the contaminated fluid inlet of the first vessel is located proximate to the top portion of the first vessel,
wherein the contaminated fluid outlet of the first vessel is located proximate to the bottom portion of the first vessel, and
wherein the contaminated fluid inlet of the second vessel in fluid communication with the contaminated fluid outlet of the first vessel.

14. The apparatus of claim 13, wherein the first vessel and the second vessel each have a height less than about 11.5 feet.

15. The apparatus of claim 13, wherein the contaminated fluid inlet of the second vessel is located proximate to the bottom portion of the second vessel, and wherein the contaminated fluid outlet of the second vessel is located proximate to the top portion of the second vessel.

16. The apparatus of claim 15 further comprising a third vessel having a top portion, a bottom portion, a stripping gas inlet located between the top portion and the bottom portion, a contaminated gas outlet located proximate to the top portion, a contaminated fluid inlet located proximate to the top portion and in fluid communication with the contaminated fluid outlet of the second vessel, and a contaminated fluid outlet located proximate the bottom portion.

17. The apparatus of claim 13, wherein the contaminated fluid inlet of the second vessel is located proximate to the top portion of the second vessel, and wherein the contaminated fluid outlet of the second vessel is located proximate to the bottom portion of the second vessel.

18. The apparatus of claim 17 further comprising a lifting gas inlet in fluid communications with the contaminated fluid outlet of the first vessel, wherein a lifting gas is introduced into the lifting gas inlet to transport the contaminated fluid from the contaminated fluid outlet of the first vessel to the contaminated fluid inlet of the second vessel.

19. The apparatus of claim 17 further comprising a third vessel having a top portion, a bottom portion, a stripping gas inlet located between the top portion and the bottom portion, a contaminated gas outlet located proximate to the top portion, a contaminated fluid inlet located proximate to the top portion and in fluid communication with the contaminated fluid outlet of the second vessel, and a contaminated fluid outlet located proximate the bottom portion.

20. A system for reducing a concentration of a contaminant in a contaminated fluid comprising:
a plurality of vessels connected in series each having a top portion, a bottom portion, a stripping gas inlet located between the top portion and the bottom portion, a contaminated gas outlet located proximate the top portion, a contaminated fluid inlet, and a contaminated fluid outlet, wherein the contaminated fluid inlet of each vessel other than a first vessel in the plurality of vessels is in fluid communication with the contaminated fluid outlet of the preceding vessel;
a pump in fluid communication with the first vessel in the plurality of vessels; and
a separator in fluid communication with a last vessel in the plurality of vessels.
